(19) United States
(12) Patent Application Publication
(10) Pub. No.: US 2024/0323747 A1
(43) Pub. Date: Sep. 26, 2024

(54) FAIL OPEN MECHANISM FOR N10 INTERFACE

(71) Applicant: T-MOBILE INNOVATIONS LLC, Overland Park, KS (US)

(72) Inventors: Praveen Singaram Muthukumar, Lawrenceville, NJ (US); Sandesh Shama Shetty, Sammamish, WA (US); Rushabhkumar Patel, Newcastle, WA (US); Rahul Pal, Bothell, WA (US); Erik Kosar, Newcastle, WA (US); Agastya Kohli, Kirkland, WA (US)

(21) Appl. No.: 18/125,363

(22) Filed: Mar. 23, 2023

(51) Int. Cl. H04W 28/02; H04W 8/24; H04W 76/10

(52) U.S. Cl. CPC H04W 28/0268; H04W 8/24; H04W 28/0247; H04W 76/10

(57) ABSTRACT

Systems and methods are provided for providing communication sessions to user equipment (UE) over a telecommunications network. Specifically, communication sessions can be established for the UE despite a degraded N10 interface between a Unified Data Management function (UDM) and a Session Management function (SMF) in a 5G core network. One or more profiles comprising one or more profile parameters can be stored locally at the SMF so the one or more profile parameters can be provided to establish a communication session for a UE without receiving a response from the UDM. A locally stored profile on the SMF can be utilized when the N10 interface fails, when the UDM is experiencing congestion over a predetermined threshold, etc. Criteria that may impact the ability of the UDM to respond to queries can be identified to trigger a fetch of the profile parameters and the creation of a local profile at the SMF.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for a fail open mechanism for an N10 interface of a 5G core network. More particularly, in aspects set forth herein, systems and methods enable a Session Management Function (SMF) to create one or more default profiles to be stored locally at the SMF for use when the N10 interface is experiencing a degradation or has experienced a failure.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a diagram of an exemplary network environment in which implementations of the present disclosure may be employed, in accordance with aspects herein;

FIG. 3 depicts a flow diagram of a method for managing an N10 interface, in accordance with aspects herein;

FIG. 4 depicts a flow diagram of a method for managing an N10 interface, in accordance with aspects herein;

FIG. 5 depicts a flow diagram of a method for managing an N10 interface, in accordance with aspects herein; and

FIG. 6 depicts a diagram of an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
AMF Access & Mobility Management Function
APN Access Point Name
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCF Policy Control Function
PCS Personal Communications Service
PDA Personal Digital Assistant
RAM Random Access Memory
RET Remote Electrical Tilt
RF Radio-Frequency
RFI Radio-Frequency Interference
R/N Relay Node
ROM Read Only Memory
SINR Transmission-to-Interference-Plus-Noise Ratio
SMF Session Management Function
SNR Transmission-to-noise ratio
SON Self-Organizing Networks
TDMA Time Division Multiple Access
TXRU Transceiver (or Transceiver Unit)
UDM Unified Data Management Function
UDR Unified Data Repository
UE User Equipment
UPF User Plane Function

Further, various technical terms are used throughout this description. An illustrative resource that fleshes out various aspects of these terms can be found in Newton's Telecom Dictionary, 32d Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller.

As employed herein, a UE (also referenced herein as a user device) or WCD can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

In conventional cellular communications technology, a 5G telecommunications network comprises a 5G Core Network (5GC) and a gNB. The 5GC architecture, as known to those in the art, relies on a Service-Based Architecture (SBA) framework where the architecture elements are defined in terms of Network Functions (NF) rather than by traditional network entities. Using interfaces of a common framework, any NF can offer its services to other NFs that are permitted to make use of their functions. At times, the network interfaces can experience complete failures, degradations, and the like. This compromises the ability of other NFs to obtain necessary data to establish reliable sessions for UEs.

The present disclosure is directed to efficient management of an N10 interface, in particular. The N10 interface is the connection between the Unified Data Management Function (UDM) and the Session Management Function (SMF). Among other functions, the UDM is responsible for retrieving subscriber data from a data repository (e.g., a Unified Data Repository (UDR)) and communicating it to the SMF, which the SMF utilizes for managing user sessions on the network. The SMF queries the UDM each time a UE seeks to initiate a session on the network. The subscriber data stored at the UDM is necessary to establish these sessions. When the UDM, or the interface between the SMF and the UDM (i.e., the N10 interface), is experiencing degradations that delay or prohibit a reply to the SMF, or a complete failure of the UDM or interface renders it non-responsive, the necessary information from the UDM is unattainable and results in a failure to establish a session for the UE. Conventional systems will configure the SMF to retry the UDM until a reply is received, preventing the SMF from functioning as intended until a satisfactory response is obtained from the UDM and which results in multiple retries and additional, unnecessary noise at the UDM (or on the interface) until the issue is resolved.

The present disclosure can configure a predetermined retry configuration indicating a maximum number of retries to the UDM (e.g., 2 retry attempts) before initiating a fail open mechanism. The fail open mechanism comprises one or more or a plurality of default profiles being created and stored locally at the SMF. As further discussed herein, the default profiles can be created based on an Access Point Name (APN) (e.g., X for Internet, y for IP Multimedia Subsystem (IMS), etc.). The local profiles can be utilized when the predetermined retry configuration is met (i.e., the maximum number of retries has been attempted) and no response is received from the UDM via the N10 interface. Additional configurable parameters to initiate the fail open mechanism are discussed herein. Put simply, the creation and local storage of default profiles allows the SMF to provide the needed information for the 5GC to establish a session for the UE, instead of indicating that the UE cannot be registered due to a lack of data from the UDM via the N10 interface.

Accordingly, a first aspect of the present disclosure is directed to a system for managing a session between a UE and a cellular telecommunications network. The system comprises one or more processors and one or more computer-readable media storing computer-usable instructions that, when executed by the one or more processors, cause the one or more processors to: determine an N10 interface between a Session Management function (SMF) and a Unified Data Management function (UDM) is degraded; access one or more profile parameters for a UE from a profile stored locally at the SMF; and communicate the one or more profile parameters from the profile stored locally at the SMF to one or more components of the cellular core network to establish a first session for the UE.

A second aspect of the present disclosure is directed to a method for managing a session between a UE and a cellular telecommunications network. The method comprises determining a degradation is occurring on an N10 interface between a Session Management function (SMF) and a Unified Data Management function (UDM); obtaining Quality of Service (QoS) profile parameters; creating a plurality of profiles comprising the QoS profile parameters locally at the SMF; based on a determination the degradation exceeds a predetermined threshold, fetching one or more profile parameters from a first profile stored locally at the SMF; and communicating the one or more profile parameters from the first profile stored locally at the SMF to one or more components of the cellular core network to establish a first session for the UE.

Another aspect of the present disclosure is directed to a method for managing a session between a UE and a cellular telecommunications network. The method comprises based on a determination that an N10 interface between a Session Management function (SMF) and a Unified Data Management function (UDM) is not degraded, obtaining one or more profile parameters for a UE registration from the UDM; based on a determination that the N10 interface is degraded, fetching the one or more profile parameters for the UE on a profile stored locally on the SMF; and communicating the one or more profile parameters to one or more components of the cellular core network.

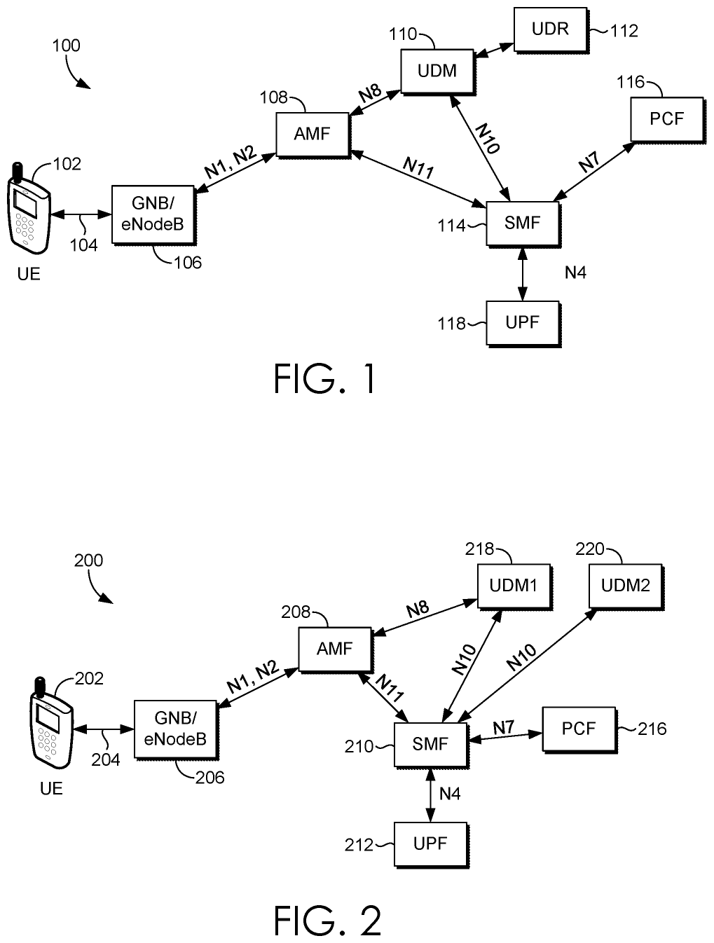

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

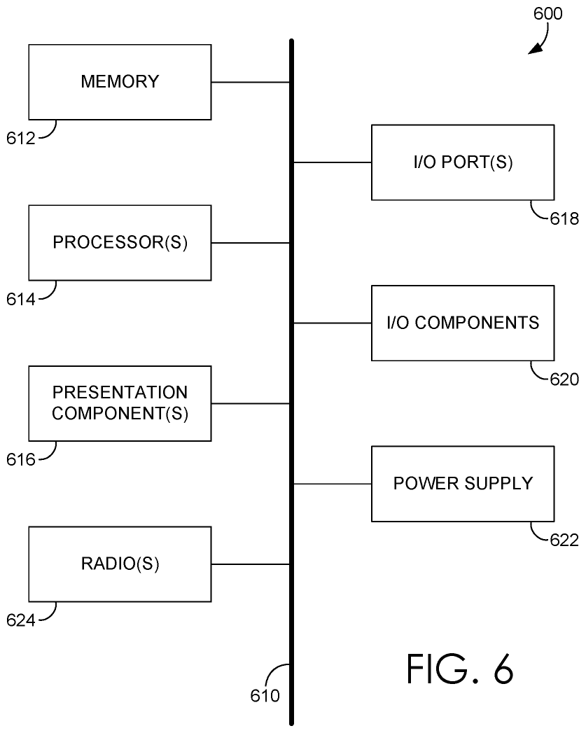

A network cell may comprise a base station to facilitate wireless communication between a communications device within the network cell, such as communications device 600 described with respect to FIG. 6, and a network. As shown in FIG. 1, communications device may be UE 102. In the network environment 100, UE 102 may communicate with other devices, such as mobile devices, servers, etc. The UE 102 may take on a variety of forms, such as a personal computer, a laptop computer, a tablet, a netbook, a mobile phone, a Smart phone, a personal digital assistant, or any other device capable of communicating with other devices. For example, the UE 102 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 102 comprises a wireless or mobile device with which a wireless telecommunication network(s) can be utilized for communication (e.g., voice and/or data communication). In this regard, the UE 102 can be any mobile computing device that communicates by way of, for example, a 5G network.

The UE 102 may utilize a network to communicate with other computing devices (e.g., mobile device(s), a server(s), a personal computer(s), etc.). In embodiments, the network is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, network 122 is associated with a telecommunications provider that provides services to user devices, such as UE 102. For example, the network may provide voice services to user devices or corresponding users that are registered or subscribed to utilize the services provided by a telecommunications provider.

Accessing the telecommunications network is initiated at the gNodeB 106 via communication link 104. The N1 and N2 interface are essential links from the UE 102 and gNodeB 106 to the Access & Mobile Function (AMF) 108. The N1 interface is a transparent interface from the UE 102 to the AMF 108. It is used to transfer UE information to the AMF 108. The N2 interface connects the gNodeB 106 to the AMF 108. N2 is important to connect the UE 102 to the network so that the UE 102 can access service. The AMF 108 handles connection and management mobility tasks. Essentially, the AMF 108 plays the role of the access point to the 5GC. The AMF 108 communicates with the Unified Data Management function (UDM) 110 and the Session Management Function (SMF) 114, among others, via the N8 and N11 interfaces, respectively. The N8 interface is the interface between the AMF 108 and the UDM 110. It is used during the registration process when the AMF 108 needs user data from the UDM 110 for UE authentication purposes. The N11 interface is the interface between the AMF 108 and the SMF 114. The SMF 114 interacts with the AMF 108 to establish, manage, and terminate sessions. Essentially, when the UE 102 requests a new session, the UE 102 and the gNodeB 106 use the N1 and N2 interfaces to carry messages to the AMF 108. The AMF 108 takes care of connection and mobility management and then passes the request on to the SMF 114 via the N11 interface.

The UDM 110 is responsible for obtaining subscriber data that the SMF 114 accesses for managing user sessions on the network. Communications between the UDM 110 and the SMF 114, including requests from the SMF 114 to the UDM 110 and responses from the UDM 110 to the SMF 114, utilize the N10 interface. The UDM 110 can obtain subscriber data requested by the SMF 114 from a Unified Data Repository (UDR) 112 that stores the user information. While only one UDR is shown for simplicity in FIG. 1, it should be understood that the UDM 110 can be associated with more than one UDR.

The SMF 114 also communicates with the Policy Control Function (PCF) 116 via the N7 interface. The communication via the N7 interface triggers session management policies towards the SMF 114. The SMF 114 further communicates with the User Plane Function (UPF) 118 via the N4 interface. The N4 interface is essential to provide necessary instructions to control and deliver the desired Quality of Service (QOS).

Returning now to the N10 interface, once the AMF 108 triggers the SMF 114 that a new session is requested, the SMF 114 queries the UDM 110 via the N10 interface for user/subscriber data. When performing as intended, the UDM 110 replies to the SMF 114 with the requested subscriber data, the SMF 114 coordinates session information with the PCF 116 and the UPF 118 and communicates back the final session information to the AMF 108 and a session is initiated for the UE 102. However, networks periodically have issues. The UDM 110 is constantly queried by multiple network functions in the 5GC. Each time a UE wants to initiate a session on the network (e.g., initiate a voice session, send a message, etc.) the UE needs to be registered with the network for the session to be initiated and this requires the UDM 110. This is a massive load for the UDM 110 and frequently the UDM 110 is unable to respond because, for instance, the N10 interface was physically disrupted (e.g., a fiber optic cable is cut) or the noise at the UDM 110 is so high that every request cannot be handled (e.g., another UDM in the network has failed and all requests directed to the failed UDM are redirected to UDM 110).

When a network function, such as the SMF 114, doesn't receive a reply to a query to the UDM 110, it is typically configured to continue to retry the query. Thus, the UDM 110 continues to receive queries for the same request, which further adds to the signal noise at the UDM 110. In other circumstances, repeated requests from the SMF 114 may never reach the UDM 110 because the N10 is disrupted, resulting in the SMF 114 not receiving a response from the UDM 110. A reply may be outstanding for a period of time that indicates a session cannot be initiated for the UE 102, and the corresponding reply is communicated to the UE 102.

Rather than not initiating a session for the UE 102, the present disclosure provides a fail open mechanism when the N10 interface is seemingly not operational (e.g., the interface was severed/has failed, the UDM 110 is experiencing congestion/degradation, etc.). In that instance, the SMF 114 can be configured with a traditional retry instruction, but the retry instruction can include a predetermined retry threshold with a maximum number of retry attempts. For example, the SMF 114 may be configured to only retry the UDM 110 in a non-responsive situation a maximum of two times, or any configurable number of times. This will help alleviate signal noise for repetitive queries to the UDM 110. Furthermore, when the predetermined retry threshold has been met (i.e., the maximum number of retry attempts have been attempted) and no reply is received via the N10 interface, the SMF 114 can be triggered to initiate the fail open mechanism.

The fail open mechanism can include creation and storage of a default profile (or a plurality of default profiles) locally at the SMF 114. Default QoS profiles can be defined per APN (e.g., X for Internet, y for IP Multimedia Subsystem (IMS), etc.). Thus, a default profile selected to use for a UE would have a profile APN that corresponds to a UE APN. The default QoS profile, which may be referred to herein as default profile or profile, can include one or more profile parameters that facilitate the normal operation of the SMF 114 in lieu of a response from the UDM 110. The profile parameters can comprise a QoS Class Identifier (QCI) value, Address Resolution Protocol (ARP) information (priority level, preemption vulnerability, preemption capability, etc.), allowed Protocol Data Unit (PDU) sessions, uplink and downlink Aggregate Maximum Bit Rate (AMBR) values, and the like. Using the fail open mechanism, the SMF 114 can send the default profile on to the PCF 116 to continue with the normal process and work toward initiating a session for the UE 102.

The creation and storage of a default profile can be triggered a variety of ways. A degradation in operation could be detected as presently occurring. A degradation, as referred to herein, is a decrease in expected performance. Expected performance can be based on historical performance or any configurable metric desired to measure performance for the fail open mechanism. Degradation can be caused by, for instance, congestion on the N10 interface. As previously discussed, the UDM 110 is constantly queried by other network functions of the 5GC network. In a situation where a degradation of the N10 interface is occurring but has not yet failed, the SMF 114 may be able to obtain subscription data/a profile from the UDM 110 and create a local version of the profile at the SMF 114 for future use in the event the N10 interface progresses from the currently experienced degradation to failure.

Degradation thresholds may be utilized to trigger the fail open mechanism and guide the SMF 114 for efficient operation. A first predetermined threshold of the degradation threshold can trigger a fetch of the profile from the UDM 110. In this instance, a degradation is identified as occurring and has reached a threshold that triggers the SMF 114 to obtain profile information from the UDM 110 while it can. Alternatively, the first predetermined threshold may trigger the SMF 114 to obtain the profile from a second UDM. This aspect is illustrated in FIG. 2. As illustrated, SMF 210 can communicate with multiple UDMs, such as UDM1 218 and UDM2 220. In the instance where UDM1 218 is experiencing degradation, SMF 210 can either obtain profile data from the UDM1 218 via a first N10 interface with UDM1 218 while it still can (since the degradation is occurring but the first N10 interface is still operating) or it can obtain the profile data from UDM2 220 via a second N10 interface. In either event, the first degradation threshold is a trigger to the SMF 114 (or SMF 210) that a local profile should be created and stored at the SMF 114.

A second predetermined threshold of the degradation threshold can trigger the SMF 114 to use the locally stored profile (i.e., stored local at the SMF 114) for future requests without requesting the profile parameters from the UDM1 218. The fail open mechanism to use the locally stored profile can remain in effect for any configurable metric such as a predetermined period of time, a predetermined number of session requests, and the like. For a UE that has a session initiated with a locally stored profile from the SMF 114 (rather than profile information received from the UDM 110), the locally stored profile can be used to maintain the session until the session is terminated by the UE 102. A session can be terminated by turning of the UE 102, activating airplane mode, sitting idle for 24 hours, or the like.

In another embodiment, a degradation or failure could have already occurred such that the N10 interface is not operational (e.g., a fiber optic cable for the N10 interface is cut). In this situation, the N10 interface does not work so the SMF 114 will need to use the locally stored profile. The locally stored profile could have already been created by the SMF 114 if the degradation was gradual and identified using the degradation thresholds described above. In the event the degradation was sudden (e.g., a cable was cut) the SMF 114 may utilize a locally stored profile if available (e.g., the SMF 114 created and stored a local profile within a predetermined period of time). In embodiments, the SMF 114 can be configured to create and/or update a local profile at a predetermined time interval. For instance, the SMF 114 may be configured to create and/or update a local profile daily, twice per day, or any other desired time interval desired.

The SMF 114 can also query another UDM (as shown in FIG. 2) to access a profile if needed or to access an updated profile if a currently stored profile is stale). For example, imagine that the first N10 interface between SMF 210 and UDM1 218 is destroyed suddenly. There was no indication that a degradation was occurring so the SMF 210 was not triggered to create a local profile. The SMF 210 could access the profile from UDM2 220 via the second N10 interface (assuming it is operating normally) and use that profile to create a locally stored profile. This allows the SMF 210 to continue to establish sessions for UEs until the first N10 interface to UDM1 218 is restored. This also eliminates recurring queries from SMF 210 to UDM2 220. This is important because SMF 210 was not originally associated with UDM2 220 so any outage with UDM1 218 would cause additional signal noise at UDM2 220 since SMF 210 would need to query UDM2 220 while UDM1 218 is non-operational. By creating a locally stored profile, UDM2 220 can carry on with the normal expected load and SMF 210 can continue operating during its N10 blackout period with UDM1 218. Meanwhile, the network can perform dead peer detection to identify when UDM1 218 is operational.

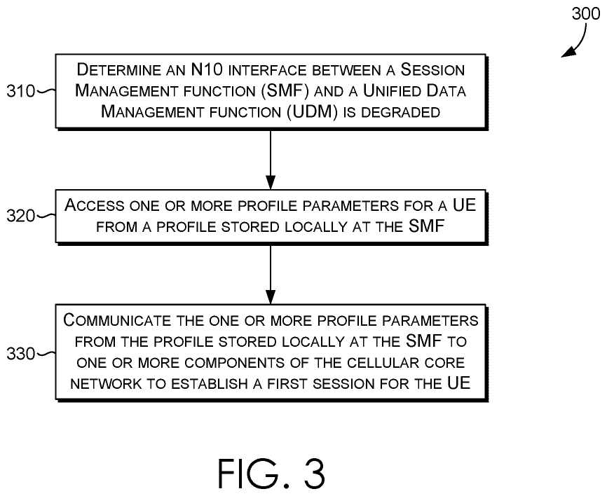

Turning to FIG. 3, a flow diagram 300 is provided illustrating a flow to manage N10 interfaces. Initially, at block 310, it is determined that an N10 interface between a SMF and a UDM is degraded. Degradation, as described above, refers to performance lower than expected performance. This may include an operational N10 interface that is poorly performing or an N10 interface that has already failed and is not operational. At block 320, one or more profile parameters for a UE from a profile stored locally at the SMF is accessed. Lastly, the one or more profile parameters from the profile stored locally at the SMF is communicated to one or more components of the cellular core network to establish a first session for the UE at block 330. The SMF can communicate the one or more profile parameters to the AMF, PCF, and the like.

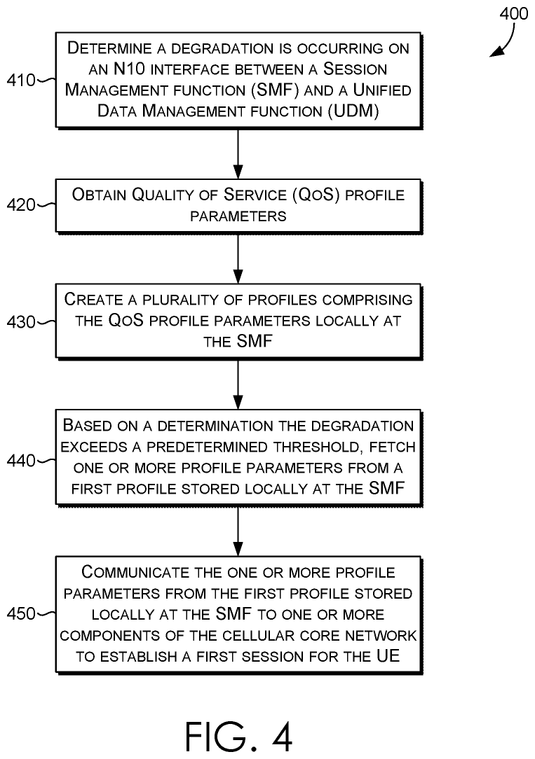

Referring to FIG. 4, a flow diagram 400 is provided illustrating a flow to manage N10 interfaces. Initially, at block 410, it is determined that a degradation is occurring on an N10 interface between a Session Management function (SMF) and a Unified Data Management function (UDM). A degradation is occurring may be determined utilizing degradation thresholds as described herein. Upon determining that a degradation is occurring, Quality of Service (QOS) profile parameters are obtained at block 420. The SMF, at block 430, creates a plurality of profiles comprising the QoS profile parameters (based on APNs) locally at the SMF. Based on a determination the degradation exceeds a predetermined threshold, fetching one or more profile parameters from a first profile stored locally at the SMF at block 440. The one or more profile parameters from the first profile stored locally at the SMF is communicated to one or more components of the cellular core network to establish a first session for the UE at block 450.

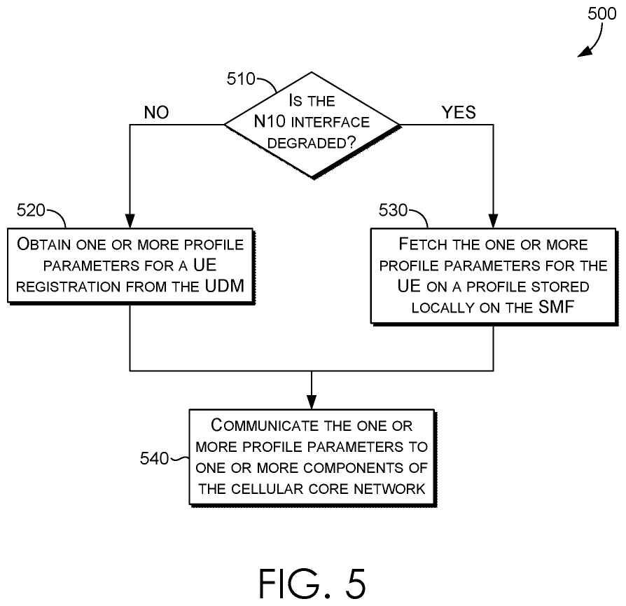

In FIG. 5, a flow diagram 500 is provided depicting a flow to manage N10 interfaces. Initially, at block 510, a decision is made whether an N10 interface is degraded. Based on a determination that an N10 interface between a Session Management Function (SMF) and a Unified Data Management function (UDM) is not degraded, one or more profile parameters for a UE registration is obtained from the UDM at block 520. Based on a determination that the N10 interface is degraded, the one or more profile parameters for the UE are fetched from a profile stored locally on the SMF at block 530. The one or more profile parameters is communicated to one or more components of the cellular core network at step 540.

Referring to FIG. 6, a block diagram of an exemplary computing device 600 suitable for use in implementations of the technology described herein is provided. In particular, the exemplary computer environment is shown and designated generally as computing device 600. Computing device 600 is but one example of a suitable computing environment and is not intended to suggest any limitation as to the scope of use or functionality of the invention. Neither should computing device 600 be interpreted as having any dependency or requirement relating to any one or combination of components illustrated. It should be noted that although some components in FIG. 6 are shown in the singular, they may be plural. For example, the computing device 600 might include multiple processors or multiple radios. In aspects, the computing device 600 may be a UE/WCD, or other user device, capable of two-way wireless communications with an access point. Some non-limiting examples of the computing device 600 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 6, computing device 600 includes a bus 610 that directly or indirectly couples various components together, including memory 612, processor(s) 614, presentation component(s) 616 (if applicable), radio(s) 624, input/output (I/O) port(s) 618, input/output (I/O) component(s) 620, and power supply(s) 622. Although the components of FIG. 6 are shown with lines for the sake of clarity, in reality, delineating various components is not so clear, and metaphorically, the lines would more accurately be grey and fuzzy. For example, one may consider a presentation component such as a display device to be one of I/O components 620. Also, processors, such as one or more processors 614, have memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 612 may take the form of memory components described herein. Thus, further elaboration will not be provided here, but it should be noted that memory 612 may include any type of tangible medium that is capable of storing information, such as a database. A database may be any collection of records, data, and/or information. In one embodiment, memory 612 may include a set of embodied computer-executable instructions that, when executed, facilitate various functions or elements disclosed herein. These embodied instructions will variously be referred to as “instructions” or an “application” for short.

Processor 614 may actually be multiple processors that receive instructions and process them accordingly. Presentation component 616 may include a display, a speaker, and/or other components that may present information (e.g., a display, a screen, a lamp (LED), a graphical user interface (GUI), and/or even lighted keyboards) through visual, auditory, and/or other tactile cues.

Radio 624 represents a radio that facilitates communication with a wireless telecommunications network. Illustrative wireless telecommunications technologies include CDMA, GPRS, TDMA, GSM, and the like. Radio 624 might additionally or alternatively facilitate other types of wireless communications including Wi-Fi, WiMAX, LTE, 3G, 4G, LTE, mMIMO/5G, NR, VOLTE, or other VoIP communications. As can be appreciated, in various embodiments, radio 624 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 618 may take a variety of forms. Exemplary I/O ports may include a USB jack, a stereo jack, an infrared port, a firewire port, other proprietary communications ports, and the like. Input/output (I/O) components 620 may comprise keyboards, microphones, speakers, touchscreens, and/or any other item usable to directly or indirectly input data into the computing device 600.

Power supply 622 may include batteries, fuel cells, and/or any other component that may act as a power source to supply power to the computing device 600 or to other network components, including through one or more electrical connections or couplings. Power supply 622 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system for managing a session between a user equipment (UE) and a cellular telecommunications network, the system comprising:
one or more processors; and
one or more computer-readable media storing computer-usable instructions that, when executed by the one or more processors, cause the one or more processors to:
determine an N10 interface between a Session Management function (SMF) and a Unified Data Management function (UDM) is degraded;
access one or more profile parameters for a UE from a profile stored locally at the SMF; and
communicate the one or more profile parameters from the profile stored locally at the SMF to one or more components of the cellular core network to establish a first session for the UE.

2. The system of claim 1, wherein the profile is accessed from a plurality of default profiles, each default profile of the plurality of default profiles being associated with an Access Point Name (APN), and wherein a UE APN of the UE corresponds to a profile APN of the profile.

3. The system of claim 1, wherein the one or more profile parameters is communicated to a Policy Control function (PCF).

4. The system of claim 1, wherein the one or more profile parameters comprises one or more of: a Quality of Service (QOS) Class Identifier (QCI) value, Address Resolution Protocol (ARP) information, Protocol Data Unit (PDU) session types, and uplink and downlink Aggregate Maximum Bit Rate (AMBR) values.

5. The system of claim 1, wherein degradation is congestion above a congestion threshold identified at the UDM.

6. The system of claim 1, wherein the degradation is a failure of the N10 interface.

7. The system of claim 1, wherein the processors:
initiate a retry query to the UDM after the first session has terminated;
receive a subscription fetch response from the UDM comprising QoS parameters for the UE; and
communicate the QoS parameters from the UDM to the one or more components of the cellular core network to establish a second session for the UE.

8. A method for managing a session between a user equipment (UE) and a cellular telecommunications network, the method comprising:
determining a degradation is occurring on an N10 interface between a Session Management function (SMF) and a Unified Data Management function (UDM);
obtaining Quality of Service (QOS) profile parameters;
creating a plurality of profiles comprising the QoS profile parameters locally at the SMF;
based on a determination the degradation exceeds a predetermined threshold, fetching one or more profile parameters from a first profile stored locally at the SMF; and
communicating the one or more profile parameters from the first profile stored locally at the SMF to one or more components of the cellular core network to establish a first session for the UE.

9. The method of claim 8, wherein a degradation threshold exceeding a first predetermined threshold triggers a fetch of the QoS profile parameters from the UDM.

10. The method of claim 9, further comprising identifying that the degradation threshold has exceeded a second predetermined threshold triggering the fetch of the one or more profile parameters from the first profile stored locally at the SMF without requesting the profile parameters from the UDM.

11. The method of claim 8, wherein the QoS profile parameters are obtained from a second UDM via a second N10 interface.

12. The method of claim 8, wherein the QoS profile parameters are obtained based on one or more Access Point Names (APN) of one or more UEs.

13. The method of claim 8, wherein the first profile is accessed from a plurality of default profiles stored locally at the SMF, each default profile of the plurality of default profiles being associated with an Access Point Name (APN), and wherein a UE APN of the UE corresponds to a profile APN of the first profile.

14. The method of claim 8, further comprising communicating the one or more profile parameters to a Policy Control function (PCF).

15. The method of claim 8, further comprising communicating the one or more profile parameters to an Access & Mobility function (AMF).

16. The method of claim 8, further comprising:
initiating a retry query to the UDM after identifying that the first session has terminated;
receiving a subscription fetch response from the UDM comprising updated QoS parameters for the UE; and
communicating the updated QoS parameters from the UDM to the one or more components of the cellular core network to establish a second session for the UE.

17. A method for managing a session between a user equipment (UE) and a cellular telecommunications network, the method comprising:
based on a determination that an N10 interface between a Session Management function (SMF) and a Unified Data Management function (UDM) is not degraded, obtaining one or more profile parameters for a UE registration from the UDM;
based on a determination that the N10 interface is degraded, fetching the one or more profile parameters for the UE on a profile stored locally on the SMF; and
communicating the one or more profile parameters to one or more components of the cellular core network.

18. The method of claim 17, wherein the N10 interface is not degraded when a subscription fetch response is received from the UDM in response to a subscription fetch request from the SMF.

19. The method of claim 18, wherein the N10 interface is degraded when a subscription fetch response is not received from the UDM in response to a subscription fetch request from the SMF.

20. The method of claim 18, wherein the N10 interface is degraded when a degradation threshold exceeds a predetermined threshold.
